(19) United States
(12) Patent Application Publication
(10) Pub. No.: US 2014/0124368 A1
(43) Pub. Date: May 8, 2014

(54) ELECTROCHEMICAL BIOSENSOR STRIP

(71) Applicant: BIOTEST MEDICAL CORPORATION, Taichung City (TW)

(72) Inventor: Maggie CHU, TAICHUNG CITY (TW)

(73) Assignee: BIOTEST MEDICAL CORPORATION, TAICHUNG CITY (TW)

(21) Appl. No.: 13/669,482

(22) Filed: Nov. 6, 2012

(51) Int. Cl. G01N 27/327

(52) U.S. Cl. 204/403.15

(57) ABSTRACT

An electrochemical biosensor strip is disclosed in the present invention. The electrochemical biosensor strip includes a substrate, an electrode system and a test reagent. The electrode system is disposed on the substrate and is composed of a hydrophilic carbon layer. The test reagent is laid on the substrate and in contact with a portion of the hydrophilic carbon layer. In such a manner, the test reagent can contact the carbon layer without interference, and the dissolved test reagent, the analyte-containing fluid and the product of the interaction of the test reagent and the analyte, while in use, can spread on the hydrophilic carbon layer spontaneously and uniformly, which makes contribution to a better detection performance.

### BACKGROUND OF THE INVENTION

1. Field of the Invention

The present invention relates to a test strip, and more particularly to an electrochemical biosensor strip.

2. Description of the Related Art

There are some biosensor strips already available in the market for measuring specific components in a biological fluid, such as human blood, urine, and etc. Such biosensor strips are operable by users themselves in house.

U.S. Pat. No. 7,316,766 discloses an electrochemical biosensor strip, which has a base, an electrode system laid on the base, a test reagent applied on a portion of the electrode system, and a hydrophilic layer laid between the base and the test reagent, in which the application of the hydrophilic layer contributes to a stronger bond of the test reagent and the base.

However, such design of '766 easily leads to several defects. For example, the manufacture of biosensor strip of '766 requires precision application of the hydrophilic layer, otherwise the hydrophilic layer can greatly interfere with the signal transmission of the electrode system. Besides, even if the test reagent makes direct contact with the electrode system, the detecting result can still be inaccuracy. This is so because the carbon layer in the electrode system is hydrophobic, and the biological fluid to be tested and the dissolved test reagent would have difficulty to apply uniformly on the hydrophobic carbon layer of the electrode system, and thus the detection of signals is affected. Such facts have become a dilemma, i.e. whether to apply the hydrophilic layer or not, for the biosensor manufacturer.

### SUMMARY OF THE INVENTION

It is the main object of the present invention to provide an electrochemical biosensor strip whose test reagent directly contacts the electrode with improved detection performance.

To achieve this and other objects of the present invention, an electrochemical biosensor strip is provided and includes a substrate, an electrode system and a test reagent. The electrode system is disposed on the substrate and is composed of a hydrophilic carbon layer. The test reagent is laid on the substrate and in contact with a portion of the hydrophilic carbon layer.

By means of the application of the hydrophilic carbon layer, the test reagent can contact the carbon layer without interference, and the dissolved test reagent, the analyte-containing fluid and the product of the interaction of the test reagent and the analyte, while in use, can spread on the hydrophilic carbon layer spontaneously and uniformly, which makes contribution to a better detection performance.

Other advantages and features of the present invention will be fully understood by reference to the following specification in conjunction with the accompanying drawings, in which like reference signs denote like components of configuration.

### BRIEF DESCRIPTION OF THE DRAWINGS

FIG. 1 is a sectional view of an electrochemical biosensor strip in accordance with a first embodiment of the present invention.

FIG. 2 is a sectional view of an electrochemical biosensor strip in accordance with the second embodiment of the present invention.

### DETAILED DESCRIPTION OF THE INVENTION

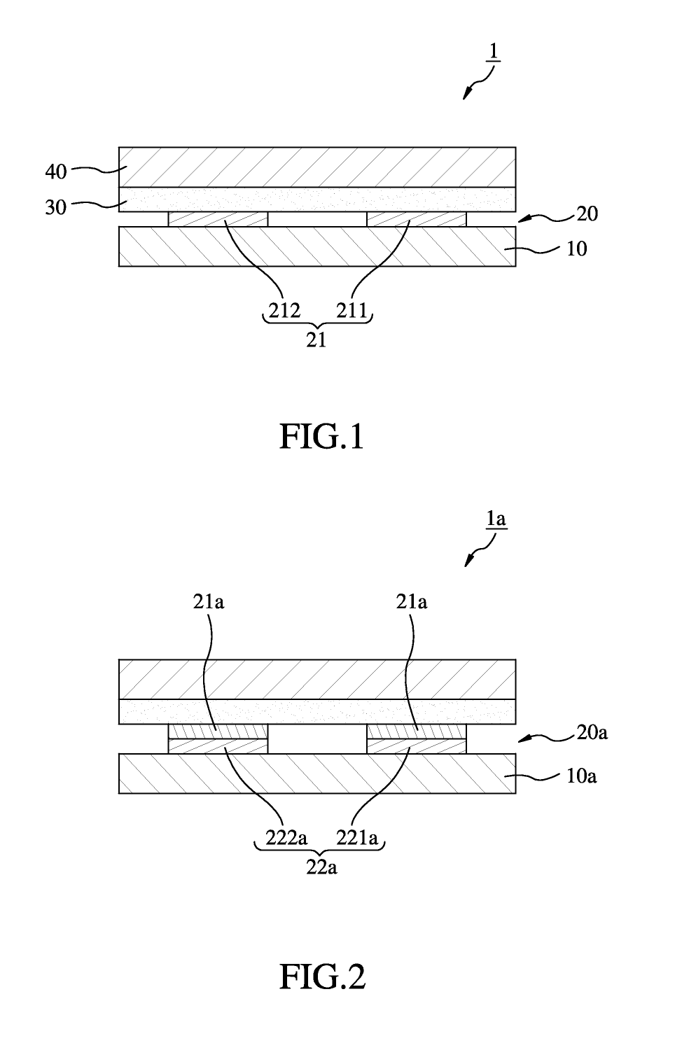

Please refer to FIG. 1 for an electrochemical biosensor strip 1, hereinafter referred to as “biosensor”, in accordance with the first embodiment of the present invention. The biosensor 1 includes a substrate 10, an electrode system 20, a test reagent 30 and an optional cover 40 for protecting the test reagent 30.

The substrate 10 is usually rectangular in shape, but the substrate 10 can also be shaped otherwise suitable. The material to make the substrate 10 includes but not limited to polyvinylchloride (PVC) and Polyethylene terephthalate (PET).

The electrode system 20 is disposed on the substrate 10 and is composed of a hydrophilic carbon layer 21. Preferably, the hydrophilic carbon layer 21 has a working electrode 211, a counter electrode 212 and an optional reference electrode (not shown). The hydrophilic carbon layer 21 is made of a mixture of carbon particles and 0.1-25 wt % of hydrophilic material, which can be surfactant, water soluble cellulose and a combination thereof. The surfactant is selected from the group consisting of Triton® (ex. Triton® X-100, Triton® X-114), Span® (ex. Span® 20, Span® 80), TWEEN® (ex. TWEEN®20, TWEEN® 80) and Tergitol, Type TMN-6 and a combination thereof.

The test reagent 30 is laid on the substrate 10 and in contact with a portion of the hydrophilic carbon layer 21. The test reagent 30, for example, can be made of bio-active compounds such as enzymes or antibodies, which can interact with analytes to be measured. When the test reagent 30 interacts with the analytes in a biological fluid, a current or a potential difference may be produced in the electrode system 20, which can be detected or measured by a measuring apparatus (not shown). Since the test reagent 30 is in direct contact with the hydrophilic carbon layer 21 without interference, the analyte-containing fluid, the dissolved test reagent 30, and the product of the interaction of the analyte and the test reagent 30, while in use, can spread uniformly on at least the portion of the hydrophilic carbon layer 21 covered by the test reagent 30, and therefore the detection or measurement of the analytes can be more accuracy.

Please refer to FIG. 2 for another biosensor 1a in accordance with the second embodiment of the present invention. It is possible that the biosensor 1a further includes a silver paste layer 22a laid between the electrode system 20a and the substrate 10a. The silver paste layer 22a can also have a working electrode 221a and a counter electrode 222a. The application of the silver paste layer 22a helps increase the conductivity of the hydrophilic carbon layer 21a and the bonding between the hydrophilic carbon layer 21a and the substrate 10a.

It is also possible that the hydrophilic carbon layer 21 itself is made paste-like. In such instance, the material of the hydrophilic carbon layer 21 can further include electrolyte besides the carbon particles and the hydrophilic material.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An electrochemical biosensor strip, comprising:
a substrate;
an electrode system, disposed on the substrate and being composed of a hydrophilic carbon layer;
a test reagent, laid on the substrate and in contact with a portion of the hydrophilic carbon layer.

2. The electrochemical biosensor strip of claim 1, wherein the hydrophilic carbon layer is made of a mixture of carbon particles and 0.1-25 wt % of hydrophilic material.

3. The electrochemical biosensor strip of claim 2, wherein the hydrophilic material is selected from the surfactant, such as Triton X-100, Triton X-114), Span 20, Span 80, TWEEN 20, TWEEN 80 and Tergitol Type TMN-6, and a combination thereof.
